(19) United States
(12) Patent Application Publication
(10) Pub. No.: US 2010/0010186 A1
(43) Pub. Date: Jan. 14, 2010

(54) High Strength Polyethylene Fiber

(75) Inventors: Nobuyuki Taniguchi, Ohtsu-shi (JP); Yasuo Ohta, Ohtsu-shi (JP); Benjamin Chu, New York, NY (US); Benjamin S. Hsiao, New York, NY (US)

Correspondence Address: FISH & RICHARDSON P.C., P.O. BOX 1022, MINNEAPOLIS, MN, 55440-1022, US

(73) Assignees: TOYO BOSEKI KABUSHIKI KAISHA, Osaka (JP); THE RESEARCH FOUNDATION OF STATE UNIVERSITY OF NEW YORK, Albany, NY (US)

(21) Appl. No.: 12/169,300

(22) Filed: Jul. 8, 2008

(51) Int. Cl. C08F 110/02

(52) U.S. Cl. 526/352

(57) ABSTRACT

The present invention provides a high strength polyethylene fiber having an intrinsic viscosity of from about 5 dL/g to 40 dL/g, and containing carbon nanofiber modified with alkyl chains. The fiber obtained by the production method of a high strength polyethylene fiber of the present invention is industrially applicable to a wide range and greatly contributes to the industry.

### TECHNICAL FIELD OF THE INVENTION

The present invention relates to a high strength polyethylene fiber superior in the strength and elastic modulus. More particularly, the present invention relates to a high strength polyethylene fiber superior in the stretchability, which has a higher strength, a higher elastic modulus and high producibility.

### DISCLOSURE OF THE INVENTION

### Problems to be Solved by the Invention

Conventionally, many attempts have been made to achieve an organic fiber having high strength and high elastic modulus, and a technique for achieving high strength and high elastic modulus of a fiber is widely known, which comprises stretching a resin made of flexible molecules having a high molecular weight at a higher draw ratio. As a representative spinning method relating to such technique, what is called a “gel spinning method” using polyethylene having an ultrahigh molecular weight as a starting material and enabling ultradrawing by using a solvent is known and has already been widely used industrially (e.g., see Japanese patent documents JP-B-60-47922 and JP-B-64-8732).

In recent years, a high strength polyethylene fiber is used not only for the above-mentioned application but also in a wide field, and more uniformity and higher strength/higher elastic modulus are strongly demanded to meet the properties requested for the fiber.

### Problems to be Solved by the Invention

As a means for satisfying these wide-ranged requests, a method using carbon nanotube (hereinafter to be referred to as CNT) as a composite has been proposed recently. As known well, in CNT, carbons having a 6-membered ring structure (graphite surface) form a cylindrical structure. Its diameter is about 0.5 nm-about 100 nm, and the length is not less than about 50 nm. It has an extremely high aspect ratio, and markedly high dynamic strength due to the constituted 6-membered ring structure. Such superior properties of CNT is highly promising as a filler for polymer matrix, and many studies have so far been made thereon (see, e.g., PCT published patent documents WO00/69958 and WO03/69032).

However, as conflicting problems, carbon nanotube has high surface crystallinity, and the intermolecular attractive force (to be sometimes referred to as π-π interaction) between nanotubes is extremely high. As a result, the dispersibility in polymer matrix is poor and, when formed into a composite, the properties do not show sufficiently. In addition, its higher cost than conventional fillers poses a major problem in industrialization.

A carbon material having a similar form as carbon nanotube is carbon nanofiber (hereinafter to be referred to as CNF). CNF is a fiber-like carbon material having a diameter of generally several 100 nm-1 μm, and a length of several μm-several 100 μm. It has a greater diameter than CNT, and the inside thereof is constituted with a substantially crystalline carbon. While CNF has somewhat lower as compared to CNT, its dynamic properties are strikingly high as compared to conventional polymer materials, and CNF is a material comparable to CNT in terms of the properties of a filler. In addition, CNF shows smaller attractive intermolecular interaction between CNFs since it has a greater diameter than CNT, and is advantageously superior in the dispersibility.

The superiority of CNF is easiness of surface modification by chemical reaction as compared to CNT. Generally, the surface of CNT has high crystallinity, which is the factor of the superior dynamic properties characteristic of CNT. On the other hand, high crystallinity means inferiority in the chemical reactivity of the surface. In contrast, the structure of CNF comprises the inside having high crystallinity, but the surface is covered with non-crystalline carbon (amorphous carbon). Since the non-crystalline carbon has a weaker binding force between carbon atoms as compared to crystalline carbon, it is considered susceptible to chemical reaction. The property indicates that CNF, when chemically modifying the surface, permits easy chemical modification as compared to CNT.

An attempt to improve the dynamic properties of a material by chemically modifying the surface of CNF utilizing such property of CNF, and making a composite with polypropylene and ultrahigh molecular weight polyethylene has been reported (see, e.g., PCT published application WO05/84167 and Macromolecules, vol. 38, page 3883 (2005). However, no specific report relating to the application to a high strength polyethylene fiber is present, and specific, appropriate conditions and the like are unknown.

### Means of Solving the Problems

The present inventors have conducted intensive studies and succeeded in providing a novel high strength polyethylene fiber, which affords a high draw ratio not obtainable by a conventional gel spinning method, by making a composite of CNF having a chemically-modified surface and optimizing the conditions therefor, which resulted in the completion of the present invention.

Accordingly, the present invention provides the following constitutions.
[1] A high strength polyethylene fiber having an intrinsic viscosity of from about 5 dL/g to 40 dL/g, comprising carbon is nanofiber modified with alkyl chains.
[2] The high strength polyethylene fiber of [1], wherein the carbon nanofiber is present in the fiber within a weight ratio from 0.05% to 10% with respect to the fiber.
[3] The high strength polyethylene fiber of [1}, wherein the fraction of alkyl chains in the modified carbon nanofiber is from 8% by weight to 20% by weight.
[4] The high strength polyethylene fiber of [1}, wherein the alkyl chains in the modified carbon nanofiber are liner alkyl chains having 8 or more carbon atoms.
[5] The high strength polyethylene fiber of [4], wherein the alkyl chains in the modified carbon nanofiber are octadecyl chains having 18 carbon atoms.
[6] The high strength polyethylene fiber of [1], which is produced by the method comprising the following steps:
(1) dispersing the modified carbon nanofiber in a solvent of polyethylene,
(2) preparing a mixed dope comprising a polyethylene as a solute, the modified carbon nanofiber and the solvent by mixing the polyethylene in a suspension obtained in the step (1), the concentration of the polyethylene is not less than 0.5 wt. % and less than 50 wt. %,
(3) extruding the dope as prepared in step (2) through a spinneret, subsequently cooling the extruded dope, and drawing the extruded and cooled dope into a filament yarn.
[7] The high strength polyethylene fiber of [1], wherein the modified carbon nanofiber is produced by the method comprising the following steps:
(1) generating carboxylic groups on carbon nanofibers by oxidation of the carbon nanofibers,
(2) generating alkyl chains on carbon nanofibers by reaction of alkyl chains having amine as an end group with the carboxylic groups generated on the carbon nanofibers in step (1).

### Effect of the Invention

According to the present invention, a high draw ratio can be achieved by merely adding a trace amount of a surface-modified carbon nanofiber and, as a result, a high strength polyethylene fiber having a superior strength elastic modulus not obtainable by a conventional gel spinning technique can be advantageously provided.

In addition, by the conventional gel spinning technique, broken threads occur most in a multiple-stage stretching step, thus decreasing the productivity. However, since the polyethylene fiber of the present invention increases the limit draw ratio at which the broken threads are developed, the incidence of broken thread can be decreased while maintaining the conventional strength and elastic modulus, and a polyethylene fiber having high productivity can be advantageously provided.

### BRIEF DESCRIPTION OF THE DRAWING(S)

FIG. 1 is a schematic phase diagram of polyethylene near melting point.

FIG. 2 shows alkyl chain fraction dependency of hexagonal crystal fraction in fiber under stretch

### BEST MODE FOR CARRYING OUT THE INVENTION

The present invention is described in detail in the following. As for the method of obtaining the fiber of the present invention, a novel method is necessary and, for example, the following method is recommended, though the method is not limited thereto.

First, the production method of a carbon nanofiber having a surface chemically modified by alkyl chain is explained.

The carbon nanofiber (CNF) in the present invention is, as mentioned above, a fiber-like carbon material, having a diameter of 100 nm-1 μm, and a length of several μm-several 100 μm. It has a greater diameter as compared to CNT, and the inside is constituted with substantially crystalline carbon.

Then, the chemical modification to be applied to CNF is explained. When an alkyl chain is introduced into the surface of CNF by chemical modification, the affinity for a spinning solvent and a polyethylene matrix increases to facilitate dispersing. Besides these, since the affinity for polyethylene increases, when the fiber is formed, stress transmission efficiency from polyethylene (the fiber inside) to CNF becomes high. Thus, chemical modification is important.

The first step of chemical modification is introduction of an acidic functional group such as carboxyl group (—COOH), hydroxyl group and the like into the surface of CNF using a strong acid. While the strong acid used for introduction of an acidic functional group is not particularly limited, for example, potassium chlorate, potassium perchlorate, hydrochloric acid, sulfuric acid, nitric acid, and a mixture thereof can be mentioned. The necessary temperature for acid treatment is 0-100° C., preferably 30-70° C.

The time necessary for the acid treatment is particularly important since it affects, as mentioned below, the ratio of alkyl chain produced in the second step of the chemical modification of the surface relative to the whole amount of surface-modified CNF, and strongly affects the stretchability of the fiber. The reason therefor is that acidic functional group introduced into the surface by acid treatment reacts with the molecule used in the second step of the chemical modification, whereby the alkyl chain is introduced into the surface of CNF. The time necessary for the acid treatment is 10 min-48 hr, preferably 30 min-24 hr. When the time of acid treatment is prolonged, a greater number of alkyl chains can be introduced later, but when the time of acid treatment is prolonged too much, CNF is unpreferably decomposed. Since the amount of surface area of CNF is limited, and the number of reaction sites is also limited, an acid treatment for a long time is meaningless.

Then, as the second step of chemical modification, a step wherein an alkyl chain is introduced into CNF (hereinafter, oxidized CNF), into which the acidic functional group has been introduced by the aforementioned acid treatment, to produce CNF having an alkyl chain introduced into the surface (hereinafter, surface-modified CNF) is explained. The reagent for introducing an alkyl chain into oxidized CNF is not particularly limited as long as it can be bonded to an acidic functional group (carboxyl group, hydroxyl group and the like). Examples thereof include alkyl chain having a chemical structure containing amine at the terminal (octylamine, decylamine, dodecylamine, hexadecylamine, octadecylamine, alkyl chain containing amine at the terminal etc.). The structure of the alkyl chain is not particularly limited, and it may be branched.

The reaction is performed by dispersing the oxidized CNF in the aforementioned reagent. At this time, a small amount of a solvent (e.g., dimethyl sulfoxide) may be concurrently used to disperse oxidized CNF.

The reaction of the oxidized CNF with the aforementioned reagent is performed at 100° C.-300° C., preferably 150° C.-250° C., more preferably 170-200° C. In addition, the reaction can be carried out in an inert gas such as nitrogen and argon. The reaction time is 12-30 hr, preferably 15-25 hr.

After the completion of the reaction, the reaction mixture is filtered, and the reaction product is washed with a wash solvent. The wash solvent is not particularly limited, and preferably, appropriately selected and used according to the reagent. For example, organic solvents such as tetrahydrofuran, ethanol, chloroform, hexane and the like, or a mixture thereof can be mentioned. Then by vacuum drying (50-90° C.) and removal of the residual solvent, surface-modified CNF, wherein the surface is modified by alkyl chain, can be obtained.

The amount of the alkyl chain modifying the surface of CNF can be measured by thermogravimetric analysis (TGA). When the atmospheric gas is the air, a weight decrease is observed at a temperature (about 600° C.) of decomposition of the original CNF and a weight decrease accompanying decomposition of alkyl chain is observed at 200-400° C. depending on the kind of the alkyl chain used for modification. For example, when octadecyl chain is used as an alkyl chain, a weight decrease of octadecyl chain occurs at about 370° C.

The content of alkyl chain in the surface-modified CNF is particularly important since it greatly influences the stretchability of the fiber in the present invention. Preferably, the weight fraction is 8-20%, more preferably 10-20%. When the content of the alkyl chain is less than 8%, the stress transmission efficiency from polyethylene inside the fiber to CNF decreases during formation and stretching of the fiber, since the affinity between polyethylene and CNF becomes small. On the other hand, when the content of the alkyl chain exceeds 20%, the stress transmission efficiency is not improved, since the surface area of CNF is limited.

Now, polyethylene, which is the starting material used in the present invention, is explained.

For production of the fiber, high molecular weight polyethylene to be the starting material needs to have an intrinsic viscosity [η] of not less than 5 dL/g, preferably not less than 8 dL/g, more preferably not less than 10 dL/g. When the intrinsic viscosity is less than 5 dL/g, a desired high strength fiber having a strength exceeding 20 cN/dtex cannot be obtained. The upper limit needs to be not more than 40 dL/g, preferably not more than 35 dL/g, more preferably not more than 30 dL/g, still more preferably not more than 25 dL/g. When the intrinsic viscosity is too high, the processability is degraded to often make it difficult to produce a fiber.

The ultrahigh molecular weight polyethylene in the present invention is characterized in that its repeat unit is substantially ethylene, and may be a copolymer with a small amount of other monomer, for example, α-olefin, acrylic acid and a derivative thereof, methacrylic acid and a derivative thereof, vinylsilane and a derivative thereof, and the like, or a copolymer of these copolymers, or a copolymer with an ethylene homopolymer, or further, a blend with other homopolymer such as α-olefin and the like. Particularly, it is more preferable to contain short chain or long chain branch to a certain extent by the use of a copolymer of α-olefin such as propylene, butene-1 and the like, since it stabilizes production of the fiber, particularly yarn making by spinning and stretching. However, when the content of components other than ethylene increases too much, it prevents stretching. Thus, from the aspects of production of a fiber having high strength•high elastic modulus, the monomer unit is desirably not more than 0.2 mol %, preferably not more than 0.1 mol %. Needless to say, it may be a homopolymer of ethylene alone.

An ultrahigh molecular weight polyethylene and surface-modified CNF can be mixed by a known method. To be specific, a solution mixing method wherein surface-modified CNF is dispersed in a solvent of an ultrahigh molecular weight polyethylene to give a surface-modified CNF dispersion, which is mixed with a solution of the ultrahigh molecular weight polyethylene, a method wherein an ultrahigh molecular weight polyethylene is mixed with a dispersion of surface-modified CNF, a method wherein ultrahigh molecular weight polyethylene and surface-modified CNF are mixed in a twin screw kneader, and the like can be used. To facilitate dispersion of surface-modified CNF in the finally-obtained fiber, a method using a dispersion of surface-modified CNF is preferable.

While the method of dispersing surface-modified CNF in a solvent of polyethylene is not particularly limited, ultrasonication affords a dispersion wherein the surface-modified CNF is uniformly dispersed therein. For ultrasonication, a commercially available ultrasonic washing machine and an ultrasonication dispersion machine can be used.

For the subsequent step for affording a composite with an ultrahigh molecular weight polyethylene, mixing of a polyethylene solution with the above-mentioned surface CNF dispersion, or a method including directly feeding polyethylene into a surface-modified CNF dispersion and stirring the mixture can be employed. In the present invention, the latter method including directly feeding polyethylene into a surface-modified CNF dispersion and stirring the mixture is preferable. When a powder of ultrahigh molecular weight polyethylene is fed into a surface-modified CNF dispersion and the mixture is stirred with heating, a frog-like precipitate of a polyethylene and surface-modified CNF composite is produced in the liquid at around 100° C., and the solvent and the composite are separated once. Further stirring with heating results in dissolution of the frog-like composite in the solvent to give a gel for spinning.

In contrast, in the method including mixing a polyethylene solution and the above-mentioned surface CNF dispersion, the resulting gel has a low polyethylene concentration and the production efficiency is not good.

The amount of surface-modified CNF (B) relative to ultrahigh molecular weight polyethylene resin (A) in a weight ratio is (A):(B)=90:10-99.95:0.05, preferably (A):(B)=95:5-99.9:0.1, more preferably (A):(B)=99.5:0.5-99.9:0.1. When the content of the surface-modified CNF is small, the stretchability improving effect is low. Conversely, too high a content of surface-modified CNF is not preferable, since undispersed surface-modified CNF acts as a foreign substance to induce broken thread during spinning and/or stretching, and degrades the stretchability and fiber properties.

In the production method recommended in the present invention, a volatile organic solvent such as decalin and/or tetralin and the like is preferably used as a solvent for dissolving the above-mentioned ultrahigh molecular weight polyethylene. Use of a solvent which is solid at ambient temperature or a non-volatile solvent markedly degrades the producibility during spinning. A volatile solvent evaporates somewhat in an early stage of spinning from the surface of a gel yarn after delivery from the spinneret. It is inconclusively assumed that a cooling effect produced by the evaporative latent heat due to the evaporation of the solvent at that time stabilizes the spinning state. The concentration is preferably not more than 30 wt %, preferably not more than 20 wt %, more preferably not more than 15 wt %. It is necessary to select an optimal concentration according to the intrinsic viscosity [η] of ultrahigh molecular weight polyethylene, the starting material. Furthermore, it is preferable to set, in spinning step, the spinneret temperature to not less than 30° C. plus the melting point of polyethylene and not more than the boiling point of the solvent used. In the temperature range near the melting point of polyethylene, the viscosity of polymer becomes too high, and the polymer cannot be taken up rapidly. In addition, at a temperature not less than the boiling temperature of the solvent used, since the solvent boils immediately after delivery from the spinneret, broken thread is frequently developed unpreferably immediately below the spinneret.

The obtained unstretched yarn is further heated, and stretched several folds while removing the solvent or, where necessary, stretched for multiple stages, whereby the aforementioned high strength polyethylene fiber having superior stretchability can be produced. At this time, the deformation rate of the fiber during stretching is an important parameter. When the deformation rate of the fiber is too fast, the fiber is unpreferably broken before reaching a sufficient draw ratio. When the deformation rate of the fiber is too slow, molecular chain relaxation occurs during stretching. This is not preferable since the fiber becomes thin due to stretching but a fiber having high properties cannot be obtained. Preferably, a deformation rate of not less than 0.005 s⁻¹ and not more than 0.5 s⁻¹ is preferable and not less than 0.01 s⁻¹ and not more than 0.1 s⁻¹ is more preferable. The deformation rate can be calculated based on the draw ratio of the fiber, stretching rate and the length of heating section in an oven. That is, the deformation rate (s⁻¹)=(1-1/draw ratio)stretching rate/length of heating section. To obtain a fiber having a desired strength, the recommended draw ratio of the fiber is not less than 10-fold, preferably not less than 12-fold, more preferably not less than 15-fold.

The stress transmission from polyethylene matrix to surface-modified CNF can be observed based on changes in crystal morphology of polyethylene under stretch. A hexagonal crystal, which is a metastable phase, appears near the melting point of polyethylene depending on the temperature range, and the stress range applied to the inside of polyethylene due to compression or stretching. By studying how the hexagonal crystal appears, the stress state of polyethylene during stretching can be known.

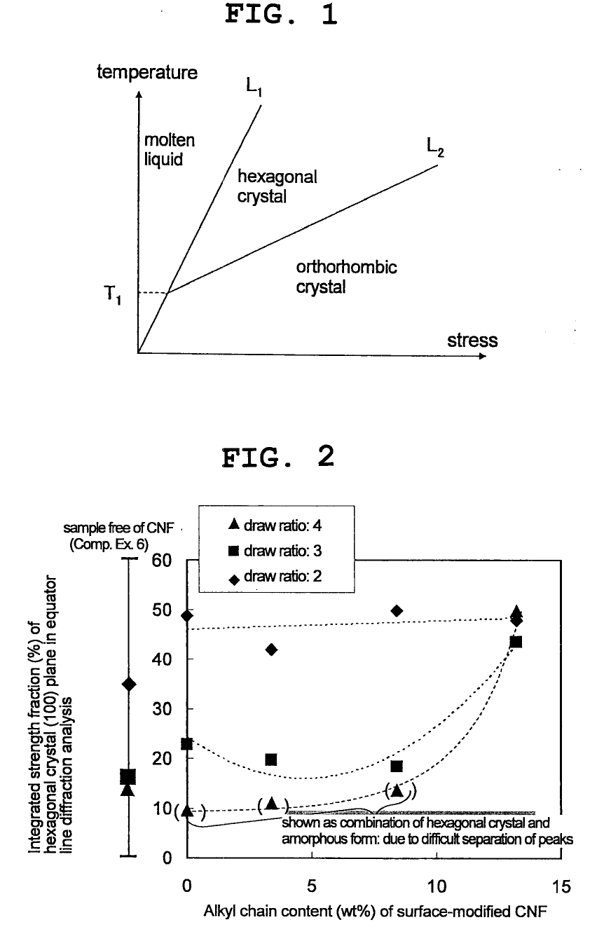

The outline of the phase diagram near the melting point of polyethylene is shown, for example, in Macromolecules, vol. 29, page 1540 (1996) and Macromolecules, vol. 31, page 5022 (1998). Polyethylene used in these references differs from the polyethylene preferable for the present invention. Accordingly, specific temperature, stress and pressure differ from those for the fiber of the present invention. However, the outline of the phase diagram is essentially the same. The schematic view is shown in FIG. 1. A hexagonal crystal appears at a temperature not less than a given temperature (hereinafter to be temporarily referred to as T1) and only in a given stress range. When the temperature is not more than T1, a hexagonal crystal does not appear. With stress of not more than the phase transition line, it becomes a molten liquid, and with stress of not less than the phase transition line, an orthorhombic crystal is obtained. On the other hand, when the temperature is not less than T1, the behavior is a molten liquid with stress•pressure of not more than phase transition line L1, a hexagonal crystal in the region of not less than L1 and not more than L2, and an orthorhombic crystal with stress•pressure of not less than L2.

The changes in the crystal morphology of polyethylene fiber under stretch can be known by X-ray diffraction test using strong X-ray. Such test can be performed using a large radiation facility. Such test is possible using a drawing machine provided with a slit type heater and by irradiating strong X-ray to the fiber passing through a heating region in the slit. A wide-angle X-ray diffraction (WAXD) pattern obtained by such test appears as a mixed pattern of orthorhombic crystal and hexagonal crystal. By separating the peak of the pattern, the fraction of the peaks occupied by respective crystals can be calculated.

Of the diffraction patterns obtained in this manner, a peak fraction of hexagonal crystal reflecting the stress condition applied to polyethylene is noted. The polyethylene fiber under stretch is subjected to a greater stress as the draw ratio increases. Therefore, when the polyethylene fiber is stretched at a temperature of not less than T1 and the draw ratio is high, only an orthorhombic crystal appears. However, when the draw ratio is low, a hexagonal crystal also appears in a mixture.

By comparison of a polyethylene fiber produced under preferable conditions in the present invention and a polyethylene fiber produced otherwise, the fraction occupied by the hexagonal crystal becomes higher for the polyethylene fiber of the present invention. This is considered to be attributable to a decreased stress applied to a polyethylene matrix, which is caused by propagation of a part of the stress to be applied to the whole fiber due to stretching, to a surface-modified CNF composite.

### EXAMPLES

The present invention is explained in detail by the following Examples, which are not to be construed as limitative.

The measurement methods and measurement conditions of the property values in the present invention are as follows.

### (Alkyl Chain Content of Surface-Modified CNF)

The alkyl chain content of surface-modified CNF was measured using a thermogravimetric analyzer (TGA), TGA-7 manufactured by Perkin Elmer, under the conditions of the air atmosphere and a temperature rise rate of 20° C./min, and a thermogravimetric curve was obtained. Assuming the weight decrease (200-400° C.) observed at a temperature lower than the decomposition (about 600° C.) of original CNF as the decomposition of alkyl chain, the weight decrease in this part was taken as the alkyl chain content.

### (Intrinsic Viscosity)

The intrinsic viscosity of polyethylene was determined by measuring specific viscosity of various dilute solutions using decalin at 135° C. and Ubbelohde capillary viscosity tube, and from the extrapolation point at the zero concentration of the straight line obtained by least mean square approximation of the plot of the values resulting from dividing the specific viscosity by the concentration, relative to the concentration. For the measurement, 1 wt % antioxidant (trade mark “YOSHINOX BHT” manufactured by Yoshitomi Pharmaceutical Industries) relative to the polymer was added to a sample, and the mixture was dissolved by stirring at 135° C. for 24 hr to prepare the measurement solution.

### (Strength and Elastic Modulus of Fiber)

The strength in the present invention was determined by determining a strain-stress curve using “TENSILON” manufactured by ORIENTIC Co., Ltd., under conditions of sample length 100 mm (length between chucks), stretching rate 100%/min, atmospheric temperature 20° C. and relative humidity 65%, and calculating the strength (cN/dTex) from the stress and elongation at fracture point. In addition, the elastic modulus (cN/dTex) was calculated from the tangent line defining the maximum gradient near the point of origin of the curve. Each value is an average of ten measurements.

For the measurement of fineness, about 2 m of each single yarn was cut out, and the weight of the single yarn (1 m) was measured and converted to 10000 m to give a fineness (dTex).

### (X-Ray Structural Analysis of Fiber Under Stretch)

The X-ray structural analysis of polyethylene fiber under stretch was performed using Synchrotoron Light Source, X27C beamline, in US Brook Haven National Laboratory (Upton, N.Y., USA). A drawing machine having a slit heater (gap 2 mm, length 30 mm) was set in such a manner that the X-ray would pass through the center of the slit heater in the gap. A yarn was passed through the gap of the heater, the position of the drawing machine was slightly adjusted so that the fiber under stretch would be exposed to the X-ray, and X-ray diffraction images were photographed using a Mar-CCD two-dimensional X-ray detector (Mar USA, Inc) as an X-ray detector. The wavelength of the X-ray was 0.1371 nm, and the distance between fiber and X-ray detector was about 10 cm (varied depending on the test).

### Example 1

### Surface Oxidation of Carbon Nanofiber

An acidic functional group (carboxyl group, hydroxyl group) was produced on the surface of carbon nanofiber (hereinafter CNF) using a mixed acid (a mixture of sulfuric acid and nitric acid). A mixture of carbon nanofiber (0.5 g, Pyrograf PR-24-HHT), concentrated sulfuric acid (37.5 mL, 95%, Sigma-Aldrich Corporation) and concentrated nitric acid (12.5 mL, Sigma-Aldrich Corporation) was ultrasonicated for 10 min to disperse CNF, and stirred at 60° C. for 24 hr. The CNF suspension was diluted with pure water, and filtered through a membrane filter having a pore size of 0.2 μm. The obtained product was washed with pure water and methanol, and dried overnight in vacuo at 70° C. to give an oxidized CNF.

### Example 2

In the same manner as in Example 1 except that the stirring time at 60° C. was set to 18 hr, an oxidized CNF was obtained.

### Example 3

In the same manner as in Example 1 except that the stirring time at 60° C. was set to 10 hr, an oxidized CNF was obtained.

### Example 4

In the same manner as in Example 1 except that the stirring time at 60° C. was set to 6 hr, an oxidized CNF was obtained.

### Example 5

### Modification of Oxidized Carbon Nanofiber With Alkyl Chain

A mixture of the oxidized carbon nanofiber obtained in Example 1 (0.4 g), dimethyl sulfoxide (8 mL, Sigma-Aldrich Corporation) and 1-octadecylamine (0.4 g, Sigma-Aldrich Corporation) was ultrasonicated for 10 min, and 1-octadecylamine (1.8 g) was added. The mixture was stirred at 180° C. for 24 hr, and filtered through a membrane filter having a pore size of 0.2 μm, and the obtained product was washed with a mixed solvent of ethanol/chloroform (volume ratio: 2/1), and dried overnight in vacuo at 70° C. to give a surface-modified CNF.

### Example 6

In the same manner as in Example 1 except that the oxidized carbon nanofiber obtained in Example 2 was used, a surface-modified CNF was obtained.

### Example 7

In the same manner as in Example 1 except that the oxidized carbon nanofiber obtained in Example 3 was used, a surface-modified CNF was obtained.

### Example 8

In the same manner as in Example 1 except that the oxidized carbon nanofiber obtained in Example 4 was used, a surface-modified CNF was obtained.

### Example 9

The surface-modified CNF (0.018 g) obtained in Example 5 was fed into decahydronaphthalene (291 g, a mixture of cis-form and trans-form), and the mixture was ultrasonicated for 1 hr to disperse the surface-modified CNF in decahydronaphthalene. To the dispersion were added ultrahigh molecular weight polyethylene having an intrinsic viscosity of 21.0 dL/g (8.982 g) and BHT as an antioxidant (1 wt % relative to polyethylene), and mixture was stirred to give a slurry liquid. While dispersing the substance, the substance was dissolved in a mixer type kneader provided with two impellers and set to 160° C. to give a gel substance. Without cooling, the gel substance was filled in a cylinder set to 170° C., and extruded at a discharge rate of 0.8 g/min from a spinneret set to 170° C. and having one hole with a diameter of 0.8 mm. The discharged dope filament was cast in a water bath via 7 cm air gap, cooled and wound up at a spinning rate of 20 m/min without removing the solvent. Then, the dope filament was vacuum dried at 40° C. for 24 hr and the solvent was removed. The obtained fiber was stretched using a slit type drawing machine set to 80° C. at a draw ratio of 4 and the stretched yarn was wound up. Then, the stretched yarn was further stretched at 143° C., the draw ratio immediately before yarn breakage was measured, and the obtained value was multiplied by 4 to give a maximum draw ratio. The maximum draw ratio and various properties of the obtained polyethylene fiber are shown in Table 1.

### Example 10

In the same manner as in Example 9 except that the surface-modified CNF obtained in Example 6 was used, a polyethylene fiber was obtained. The maximum draw ratio and various properties of the obtained polyethylene fiber are shown in Table 1.

### Example 11

In the same manner as in Example 9 except that the surface-modified CNF obtained in Example 7 was used, a polyethylene fiber was obtained. The maximum draw ratio and various properties of the obtained polyethylene fiber are shown in Table 1.

### Comparative Example 1

In the same manner as in Example 9 except that the surface-modified CNF obtained in Example 8 was used, a polyethylene fiber was obtained. The maximum draw ratio and various properties of the obtained polyethylene fiber are shown in Table 1.

### Comparative Example 2

In the same manner as in Example 9 except that a surface-unmodified CNF was used, a polyethylene fiber was obtained. The maximum draw ratio and various properties of the obtained polyethylene fiber are shown in Table 1.

### Comparative Example 3

In the same manner as in Example 7 except that a surface-modified CNF was not used, a polyethylene fiber was obtained. The maximum draw ratio and various properties of the obtained polyethylene fiber are shown in Table 1.

TABLE 1

| | | alkyl chain | | | | | |
|---|---|---|---|---|---|---|---|
| | | content | | maximum | | | |
| | oxidation | of surface- | intrinsic | draw | | | elastic |
| | time | modified | viscosity | ratio | fineness | strength | modulus |
| | [hr] | CNF [wt %] | [dL/g] | [—] | [dtex] | [cN/dTex] | [cN/dTex] |
| Ex. 9 | 24 | 14 | 17 | 22.5 | 0.53 | 42 | 1620 |
| Ex. 10 | 18 | 11 | 19 | 21.5 | 0.56 | 41 | 1522 |
| Ex. 11 | 10 | 8 | 18 | 20.0 | 0.60 | 38 | 1490 |
| Com. | 6 | 5 | 17 | 19.0 | 0.64 | 34 | 1395 |
| Ex. 1 | | | | | | | |
| Com. | — | 0 | 17 | 18.0 | 0.68 | 32 | 1370 |
| Ex. 2 | | | | | | | |
| Com. | — | — | 18 | 19.0 | 0.63 | 36 | 1415 |
| Ex. 3 | | | | | | | |

It was found that the fibers of the embodiment of the present invention had higher maximum draw ratio, higher strength and higher elastic modulus than those of the comparative examples.

### Example 12

The surface-modified CNF (0.018 g) obtained in Example 5 was fed into decahydronaphthalene (291 g, a mixture of cis-form and trans-form), and the mixture was ultrasonicated for 1 hr to disperse the surface-modified CNF in decahydronaphthalene. To the dispersion was added ultrahigh molecular weight polyethylene having an intrinsic viscosity of 21.0 dL/g (8.982 g), and mixture was stirred to give a slurry liquid. While dispersing the substance, the substance was dissolved in a mixer type kneader provided with two impellers and set to 160° C. to give a gel substance. Without cooling, the gel substance was filled in a cylinder set to 170° C., and extruded at a discharge rate of 0.8 g/min from a spinneret set to 170° C. and having one hole with a diameter of 0.8 mm. The discharged dope filament was cast in a water bath via 7 cm air gap, cooled and wound up at a spinning rate of 20 m/min without removing the solvent. Then, the dope filament was vacuum dried at 40° C. for 24 hr and the solvent was removed. The obtained fiber was stretched using a slit type drawing machine set to 80° C. at a draw ratio of 4 and the stretched yarn was wound up and used as intermediate stretch yarn A.

The intermediate stretch yarn A was drawn at draw ratios of 2, 3 and 4 at 143° C., and a wide-angle X-ray diffraction pattern was taken for each in the center of a drawing oven (slit heater). The background was subtracted from the diffraction profile obtained by integration of the range of ±5° of the diffraction pattern from the equator line. Each crystal peak was separated by curve fitting and the peak area was determined. The fraction of hexagonal crystal at each draw ratio is shown in FIG. 2 as dependency on the content of alkyl chain for surface modification.

### Example 13

In the same manner as in Example 12 except that the surface-modified CNF obtained in Example 7 was used, an intermediate stretch yarn of a polyethylene fiber was obtained. This was used as intermediate stretch yarn B.

The intermediate stretch yarn B was drawn at draw ratios of 2, 3 and 4 at 143° C., and a wide-angle X-ray diffraction pattern was taken for each in the center of a drawing oven (slit heater). The background was subtracted from the diffraction profile obtained by integration of the range of ±5° of the diffraction pattern from the equator line. Each crystal peak was separated by curve fitting and the peak area was determined. The fraction of hexagonal crystal at each draw ratio is shown in FIG. 2 as dependency on the content of alkyl chain for surface modification.

### Comparative Example 4

In the same manner as in Example 12 except that the surface-modified CNF obtained in Example 8 was used, an intermediate stretch yarn of the polyethylene fiber was obtained. This was used as intermediate stretch yarn C.

The intermediate stretch yarn C was drawn at draw ratios of 2, 3 and 4 at 143° C., and a wide-angle X-ray diffraction pattern was taken for each in the center of a drawing oven (slit heater). The background was subtracted from the diffraction profile obtained by integration of the range of ±5° of the diffraction pattern from the equator line. Each crystal peak was separated by curve fitting and the peak area was determined. The fraction of hexagonal crystal at each draw ratio is shown in FIG. 2 as dependency on the content of alkyl chain for surface modification.

### Comparative Example 5

In the same manner as in Example 12 except that a surface-unmodified CNF was used, an intermediate stretch yarn of a polyethylene fiber was obtained. This was used as intermediate stretch yarn D.

The intermediate stretch yarn D was drawn at draw ratios of 2, 3 and 4 at 143° C., and a wide-angle X-ray diffraction pattern was taken for each in the center of a drawing oven (slit heater). The background was subtracted from the diffraction profile obtained by integration of the range of ±5° of the diffraction pattern from the equator line. Each crystal peak was separated by curve fitting and the peak area was determined. The fraction of hexagonal crystal at each draw ratio is shown in FIG. 2 as dependency on the content of alkyl chain for surface modification.

### Comparative Example 6

In the same manner as in Example 12 except that a surface-modified CNF was not used, an intermediate stretch yarn of a polyethylene fiber was obtained. This was used as intermediate stretch yarn E.

The intermediate stretch yarn E was drawn at draw ratios of 2, 3 and 4 at 143° C., and a wide-angle X-ray diffraction pattern was taken for each in the center of a drawing oven (slit heater). The background was subtracted from the diffraction profile obtained by integration of the range of ±5° of the diffraction pattern from the equator line. Each crystal peak was separated by curve fitting and the peak area was determined. The fraction of hexagonal crystal at each draw ratio is shown in FIG. 2 as dependency on the content of alkyl chain for surface modification.

As is clear from FIG. 2, as the draw ratio increases, the fraction of hexagonal crystal depends on the alkyl chain content of surface-modified CNF. That is, as the amount of alkyl chain increases, the fraction of hexagonal crystal increases, approaching the fraction at a low draw ratio. This indicates that a greater alkyl content of surface-modified CNF means that the state of stress inside a polyethylene fiber is approaching the state of low draw ratio, i.e., decrease of stress applied to polyethylene. The stress decrease suggests propagation of stress to surface-modified CNF.

### INDUSTRIAL APPLICABILITY

The fiber obtained by the production method of a high strength polyethylene fiber of the present invention is industrially applicable to a wide range including high performance textile such as various sportswear, bulletproof•protective clothing•protective gloves, various safety products and the like, various rope products such as tag rope•mooring rope, yacht rope, rope for construction and the like, various braided rope products such as fishing line, blind cable and the like, net products such as fish net•net for preventing balls and the like, further, reinforcement members of chemical filter•battery separator and the like, various non-woven fabric, curtain materials such as tent and the like, reinforcing fibers for sports such as helmet, ski and the like, speaker cone, composite such as prepreg, concrete reinforcement etc., and the like.

1-5. (canceled)

6. A high strength polyethylene fiber comprising high molecular weight polyethylene (A) having an intrinsic viscosity of from about 5 dL/g to 40 dL/g and a carbon nanofiber (B) having a surface chemically-modified with alkyl chains, which is produced by the method comprising the following steps:
(1) dispersing the modified carbon nanofiber in a solvent of polyethylene,
(2) preparing a mixed dope comprising a polyethylene as a solute, the modified carbon nanofiber and the solvent by mixing the polyethylene in a suspension obtained in the step (1), the concentration of the polyethylene is not less than 0.5 wt. % and less than 50 wt. %,
(3) extruding the dope as prepared in step (2) through a spinneret, subsequently cooling the extruded dope, and drawing the extruded and cooled dope into a filament yarn at a deformation rate of not less than 0.005 s⁻¹ and not more than 0.5 s⁻¹, where the rate is calculated according to the following formula:
deformation rate (s⁻¹)=(1−1/draw ratio)×stretching rate/length of heating section.

7. The high strength polyethylene fiber of claim 6, wherein the modified carbon nanofiber is produced by the method comprising the following steps:
(1) generating carboxylic groups on carbon nanofibers by oxidation of the carbon nanofibers,
(2) generating alkyl chains on carbon nanofibers by reaction of alkyl chains having amine as an end group with the carboxylic groups generated on the carbon nanofibers in step (1).

8. The high strength polyethylene fiber of claim 6, wherein the carbon nanofiber is present in the fiber within a weight ratio from 0.05% to 10% with respect to the fiber.

9. The high strength polyethylene fiber of claim 6, wherein the fraction of alkyl chains in the modified carbon nanofiber is from 8% by weight to 20% by weight.

10. The high strength polyethylene fiber of claim 6, wherein the alkyl chains in the modified carbon nanofiber are liner alkyl chains having 8 or more carbon atoms.

11. The high strength polyethylene fiber of claim 10, wherein the alkyl chains in the modified carbon nanofiber are octadecyl chains having 18 carbon atoms.
